(19) United States
(12) Patent Application Publication
(10) Pub. No.: US 2015/0348133 A1
(43) Pub. Date: Dec. 3, 2015

(54) APPLYING CONSTRAINTS TO METRICS ASSOCIATED WITH ONLINE ADVERTISING

(71) Applicant: LinkedIn Corporation, Mountain View, CA (US)

(72) Inventors: Romer E. Rosales-Delmoral, Burlingame, CA (US); Siyu You, Santa Clara, CA (US); Deepak Agarwal, Sunnyvale, CA (US)

(73) Assignee: LinkedIn Corporation, Mountain View, CA (US)

(21) Appl. No.: 14/288,192

(22) Filed: May 27, 2014

(51) Int. Cl. G06Q 30/02

(52) U.S. Cl. CPC G06Q 30/0275; G06Q 30/0277

(57) ABSTRACT

The disclosed embodiments provide a method and system for managing online advertising. During operation, the system obtains a constraint on a first metric associated with an online advertising auction. Next, the system uses a computer to generate a tradeoff curve of the first metric and a second metric associated with the online advertising auction and use the tradeoff curve to obtain a value for the second metric that meets the constraint on the first metric. The system then uses the value to manage the online advertising auction.

### BACKGROUND

1. Field

The disclosed embodiments relate to online advertising. More specifically, the disclosed embodiments relate to techniques for applying constraints to metrics associated with online advertising.

2. Related Art

Online advertising is associated with a significant portion of Internet activity and content. Online advertisements may be served using a variety of web-based mechanisms, including emails, search engines, websites, social media, and/or mobile applications. In turn, the online advertisements may be used by various parties to earn income, advertise products or services, and/or provide public information. For example, an advertiser may run advertising campaigns on a website such as a search engine, social media website, and/or e-commerce website to increase exposure to the goods, services, and/or information advertised in the advertising campaigns. In return, the website may receive revenue from the advertiser for serving advertisements from the advertising campaigns to users and/or causing the users to click on the advertisements.

Online advertising is also frequently targeted to users based on the users' demographics, interests, and/or behavioral patterns. Such targeted advertising may allow advertisers to more easily and/or efficiently reach users who are likely to respond to the products, services, and/or information offered by the advertisers, thereby potentially increasing the impact of the advertisers' advertising campaigns and reducing overhead and/or costs over those of non-targeted advertising campaigns.

To allow multiple advertisers to run advertising campaigns within a limited space on a website, the website may run an advertising auction, in which the advertisers bid to show their online advertisements in an online advertisement slot on the website. The online advertisement slot may be in an area reserved for ads, or the online advertisement slot may be positioned within a stream or list of organic content. An online advertisement may be selected for serving in the online advertisement slot based on the attributes of the user viewing the online advertisement slot, the relevance of the advertisement to the user, and/or the bids of advertisers competing for targeting the user through advertising in the online advertisement slot. An advertiser may thus have an unsuccessful advertising campaign if the advertiser does not provide an appropriate bid for the advertising auction and/or fails to target the right audience with the advertising campaign. Similarly, the website may experience reduced user engagement if the website serves low-quality and/or irrelevant advertisements to the user.

Consequently, online advertising may be facilitated by mechanisms for improving the targeting of users by online advertisements and/or inclusion of appropriate and/or relevant online advertisements in online advertising auctions.

### BRIEF DESCRIPTION OF THE FIGURES

FIG. 1 shows a schematic of a system in accordance with the disclosed embodiments.

FIG. 2 shows a system for managing online advertising in accordance with the disclosed embodiments.

FIG. 3 shows a set of exemplary tradeoff curves in accordance with the disclosed embodiments.

FIG. 4 shows a flowchart illustrating the process of managing online advertising in accordance with the disclosed embodiments.

FIG. 5 shows a flowchart illustrating the process of generating a tradeoff curve in accordance with the disclosed embodiments.

FIG. 6 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a non-transitory computer-readable storage medium, which may be any device or medium that can store code and/or data for use by a computer system. The non-transitory computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

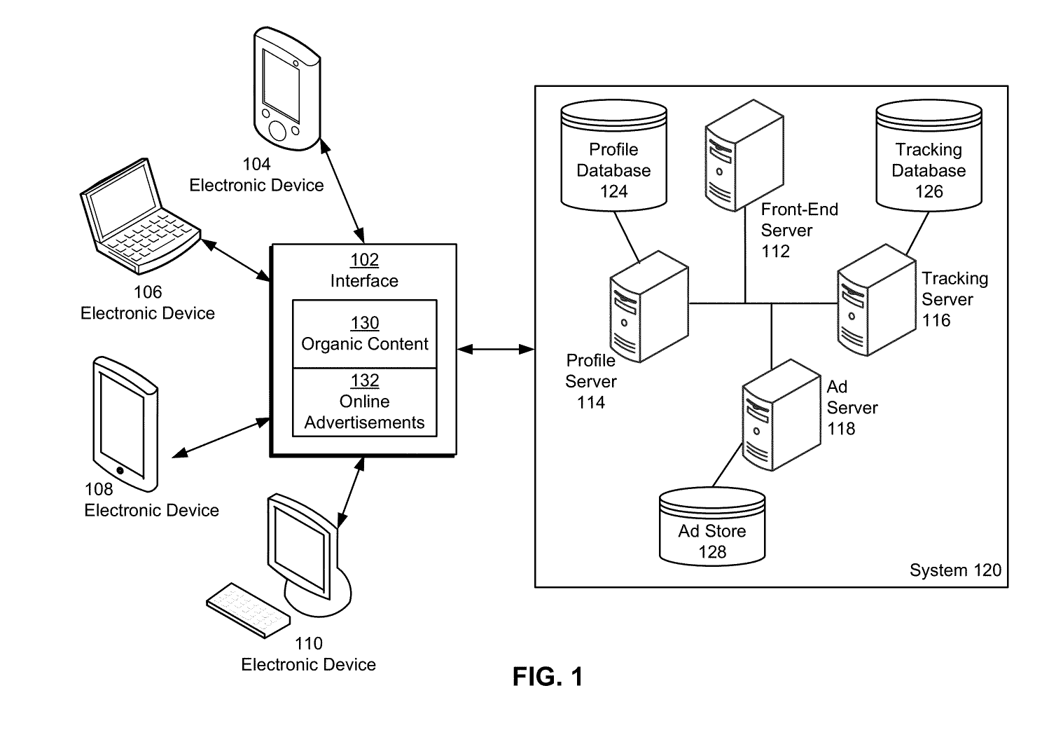

The disclosed embodiments provide a method and system for managing online advertising. As shown in FIG. 1, the online advertising may be enabled by a system 120 that serves online advertisements 132 through an interface 102 that is accessed by a set of electronic devices 104-110. For example, interface 102 may be a graphical user interface (GUI), web-based user interface, and/or other type of user interface that is provided by a web browser, mobile application, native application, and/or other application executing on a mobile phone, personal computer, laptop computer, personal digital assistant, tablet computer, portable media player, and/or other type of network-enabled electronic device.

Within interface 102, online advertisements 132 may be shown along with organic content 130. For example, a search engine may match a set of search terms to both sponsored online advertisements 132 and organic search results from the Internet. The search engine may then display both the sponsored content and organic content within the same interface 102 to users of electronic devices 104-110. In another example, a social and/or professional networking website may include online advertisements 132 in predefined regions (e.g., the sides) of interface 102 and/or intersperse online advertisements 132 among pieces of organic content 130 (e.g., posts, updates, shares, articles, etc.) generated or shared by users of the social and/or professional networking website.

Within system 120, profile server 114 may use profile database 124 to maintain user profiles of users of a service (e.g., social networking service, professional online network, portal site, search engine, web application, mobile application, etc.) hosted by system 120. A user's profile may include a set of attributes, such as personal (e.g., gender, age range, nationality), professional (e.g., job title, employer, industry, experience, skills, professional endorsements), social (e.g., organizations of which the user is a member, geographic area of residence), and/or educational (e.g., degree, university attended, certifications) attributes.

Requests for content from electronic devices 104-110 through interface 102 may be received at front-end server 112 and matched to the user profiles of users making the requests (e.g., through electronic devices 104-110). The requests may then be processed and/or tracked using one or more components of system 120, as described in further detail below.

Tracking server 116 may monitor and record activity of system 120 (e.g., in tracking database 126) and users of system 120. For example, whenever content is served from front-end server 112 (e.g., to one or more electronic devices 104-110), tracking server 116 may record the content (e.g., organic content 130, online advertisements 132, etc.) served, the user to whom the content was served, and the time at which the content was served. Tracking server 116 may also record user actions regarding content items presented to the users. For example, tracking server 116 may identify the user performing an action (e.g., using an identifier for the user), the action performed by the user (e.g., ad click, ad conversion, like, dislike, hide, follow, share, comment, etc.), and/or the content item on which the action was performed (e.g., using an ad or content identifier).

Ad server 118 may maintain one or more repositories (e.g., ad store 128) of online advertisements (e.g., online advertisements 132) for serving to users and responding to ad requests from front-end server 112. Online advertisements 132 may be stored in ad store 128 with attributes, characteristics, and/or other information describing one or more target audiences of online advertisements 132. For example, a provider of an online advertisement may identify specific attributes of users targeted by the advertisement, such as the users' demographics, locations, industries, functions, skills, backgrounds, organizations, titles, and/or seniorities. To select an online advertisement to serve in response to a request, ad server 118 may match attributes of the user associated with the request with one or more online advertisements targeting a subset of the user's attributes in ad store 128. In other words, ad server 118 may identify a user segment containing a set of attributes that match those of the user's and retrieve online advertisements targeting the user segment from ad store 128.

Those skilled in the art will appreciate that multiple online advertisements may compete for serving to a user in an online advertisement slot. To resolve the competition, ad server 118, front-end server 112, and/or another component of system 120 may run an advertising auction, in which advertisers bid on impressions or clicks of their online advertisements (e.g., online advertisements 132) by a user segment using the online advertisement slot. A winner of the advertising auction may be selected each time a request for content to be served in the online advertisement slot is received. In addition, the winner may be selected based on the bids associated with the online advertisements, the overall budgets of the advertisers placing the bids, and/or the relevance of the online advertisements to the particular user from which the request was received.

In one or more embodiments, system 120 includes functionality to manage online advertising within interface 102 by applying one or more constraints associated with online advertising metrics to online advertising auctions. Such constraints may allow system 120 to improve the quality of online advertisements 132 and/or user engagement with online advertisements 132, increase or decrease the occurrence of certain user actions with online advertisements 132, and/or estimate or optimize revenue and/or other metrics associated with online advertisements 132.

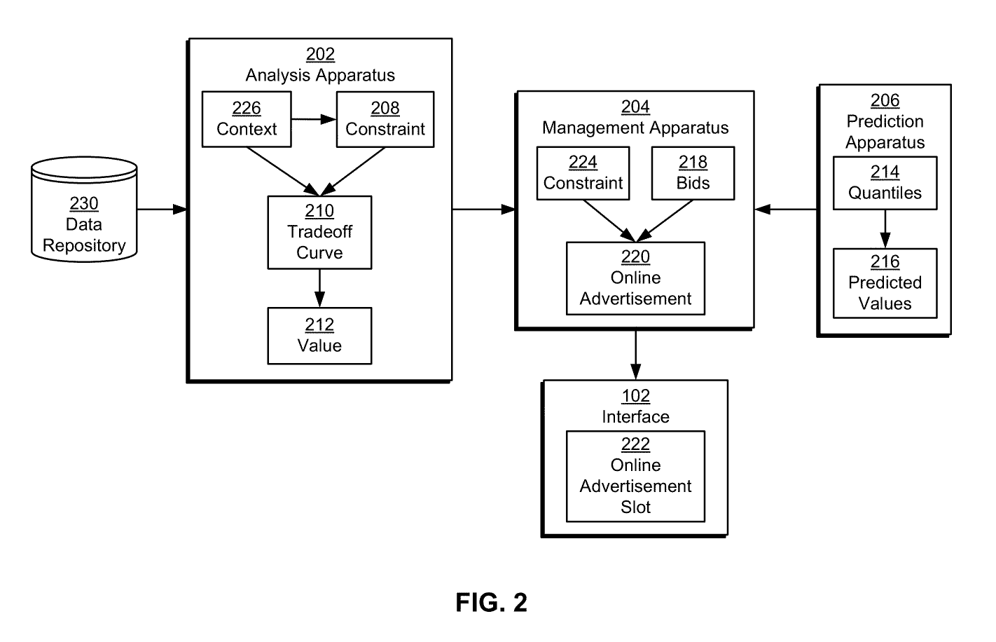

As shown in FIG. 2, an analysis apparatus 202 may enable such constraint-based management of online advertising by obtaining a context 226 associated with an online advertising auction. Context 226 may be used to customize online advertising auctions for an online advertisement 220 in an online advertisement slot 222 within interface 102. For example, context 226 may include a user or user segment, a platform, and/or a time. By identifying the user, context 226 may enable selection and serving of online advertisements that are relevant to the user and/or a user segment (e.g., based on gender, age range, location, industry, function, skill, background, organization, title, seniority, etc.) of the user. Along the same lines, inclusion of a platform or type of platform (e.g., mobile, web, desktop, operating system, etc.) in context 226 may allow serving of online advertisements to be adapted to the form factors and/or user behaviors associated with different platforms. Finally, the specification of a time or time period (e.g., hour, day of week, week of month, month, etc.) in context 226 may enable the serving of online advertisements based on different traffic and/or usage patterns associated with interface 102.

Next, analysis apparatus 202 may use context 226 to obtain a constraint 208 on a first metric associated with the online advertising auction. Constraint 208 may be a minimum or maximum threshold associated with the first metric. For example, constraint 208 may be a minimum revenue, maximum revenue loss, minimum predicted click-through rate (pCTR), a minimum expected cost-per-impression (eCPI), a minimum or maximum probability of a user action (e.g., like, dislike, comment, share, hide, follow, etc.), and/or other minimum or maximum constraint on a metric associated with user interaction with online advertisements, revenue, and/or other aspects of online advertising.

To obtain constraint 208, analysis apparatus 202 may perform a lookup of a database and/or table of constraints using context 226. Because constraint 208 is specific to context 226, constraint 208 and/or other context-specific constraints may allow management of online advertising to be tailored to various platforms, users, times, and/or other attributes associated with online advertising contexts.

Analysis apparatus 202 may then generate a tradeoff curve 210 of the first metric and a second metric associated with the same online advertising auction and/or related online advertising auctions. As with constraint 208, tradeoff curve 210 may be based on context 226. For example, analysis apparatus 202 may obtain data for generating tradeoff curve 210 from a data repository 230 such as a database, data warehouse, cloud storage, and/or other data-storage mechanism. The data may include historical data that matches context 226, such as advertising auction data for online advertising auctions from the previous week that corresponds to the time of day, day of the week, platform, and/or user or user segment of context 226. After the data is retrieved from data repository 230, analysis apparatus 202 may use the data to generate tradeoff curve 210.

To generate tradeoff curve 210, analysis apparatus 202 may use the data to generate a first set of values for the second metric based on a second set of values for constraint 208. Analysis apparatus 202 may then use the first and second sets of values as points along tradeoff curve 210.

For example, the metrics in tradeoff curve 210 may include revenue and pCTR, and data used to generate tradeoff curve 210 may include pCTRs and bids for online advertisements in one or more historical online advertising auctions that match context 226. Analysis apparatus 202 may use the pCTRs and bids to “replay” the online advertising auction(s) and determine revenues for a variety of pCTR thresholds (e.g., every 0.1% from 0% to 3%). During each online advertising auction replay, online advertisements with pCTRs that do not meet a given pCTR threshold are removed from the auction replay, and the revenue from the auction replay may be calculated as the bids from one or more participating online advertisements multiplied by the pCTR(s) of the online advertisement(s). After pairs of values for pCTR and revenue are generated from the auction replays, the pairs are used as points along tradeoff curve 210, and analysis apparatus 202 may fit tradeoff curve 210 to the points.

After tradeoff curve 210 is generated, analysis apparatus 202 may use tradeoff curve 210 to obtain a value 212 for the second metric that meets constraint 208. In particular, analysis apparatus 202 may obtain value 212 from a point on tradeoff curve 210 that matches constraint 208. Continuing with the above example, if constraint 208 is a minimum threshold for revenue and/or a maximum threshold for revenue loss (e.g., to ensure a certain amount of revenue from the online advertising auction), analysis apparatus 202 may find the point on tradeoff curve 210 corresponding to the threshold and use the other coordinate of the point as value 212 for pCTR. Conversely, if constraint 208 is a minimum threshold for pCTR (e.g., to increase user engagement and/or the quality of online advertisements in online advertisement slot 222), analysis apparatus 202 may use the pCTR threshold as one coordinate for a point on tradeoff curve 210 and obtain value 212 for revenue and/or revenue loss as the other coordinate of the point.

Value 212 may then be used by a management apparatus 204 to manage the online advertising auction and/or other online advertising auctions associated with context 226. First, management apparatus 204 may use value 212 as an estimated value for the second metric. For example, management apparatus 204 may use value 212 for revenue as an estimate of the revenue from an online advertising auction with a given pCTR threshold represented by constraint 208.

Management apparatus 204 may further aggregate a set of values for the second metric as an overall estimate of the second metric for all contexts associated with online advertisement slot 222. For example, management apparatus 204 may obtain all values for revenue generated by analysis apparatus 202 for all context-based constraints on pCTR for online advertisement slot 222 and sum the values to obtain an estimate of total revenue for online advertisement slot 222. Alternatively, if pCTR thresholds and/or revenues in one context are affected by pCTR thresholds and/or revenues in other contexts, analysis apparatus 202 and/or management apparatus 204 may use a constraint-solving technique and/or optimization technique such as quadratic programming to maximize the total revenue across all contexts.

Second, management apparatus 204 may use value 212 as an additional constraint 224 on the online advertising auctions. To enforce constraint 224, management apparatus 204 may obtain, from a prediction apparatus 206, a set of predicted values 216 of the second metric for online advertisements participating in the online advertising auction. Next, management apparatus 204 may remove a subset of the online advertisements with predicted values that do not meet constraint 224. For example, management apparatus 204 may use value 212 as a pCTR threshold (e.g., minimum pCTR) for online advertisements participating in the online advertising auction. Management apparatus 204 may also obtain a set of pCTRs for the online advertisements from prediction apparatus 206 and remove from the online advertising auction any online advertisements with pCTRs that do not meet the threshold.

Those skilled in the art will appreciate that newer online advertisements may have less historical data and, in turn, less accurate pCTRs and/or other predicted metrics than older online advertisements with more historical data. For example, the uncertainty associated with a newer online advertisement may cause the pCTR distribution for the newer online advertisement to be much flatter than the pCTR distribution for an older advertisement with more historical CTR data. As a result, the pCTR for the newer online advertisement may fall below a pCTR threshold, even if the actual CTR for the newer online advertisement is higher than the threshold.

To facilitate inclusion of both new and old online advertisements in online advertising campaigns with constraints (e.g., constraints 208 and 224), prediction apparatus 206 may generate predicted values 216 for metrics associated with the constraints based on one or more quantiles 214 of the distributions of the metrics. For example, prediction apparatus 206 may obtain a pCTR for a newer online advertisement (e.g., with a number of impressions below a pre-specified threshold) as the 85^{th} percentile of a pCTR distribution for the online advertisement to provide a more “optimistic” pCTR estimate, thereby increasing the likelihood that the online advertisement is included in an online advertising auction. On the other hand, older online advertisements may have much narrower pCTR distributions than the newer online advertisement, and thus the 85^{th} percentile of such pCTR distributions may not differ much from the median typically used to predict CTRs. As a result, prediction apparatus 206 may use either the median or the 85^{th} percentile of pCTR distributions for older online advertisements as the pCTRs of the older online advertisements with little to no change in the inclusion or exclusion of the older online advertisements in the online advertising auction.

After the online advertisements have been filtered, management apparatus 204 may run the online advertising auction and select online advertisement 220 for serving in online advertisement slot 222 based on bids 218 from advertising campaigns associated with user segment 208. For example, management apparatus 204 may select a winning online advertisement 220 from the advertiser with the highest expected cost-per-impression (eCPI), which may be the advertiser's cost-per-mille (CPM) bid or, alternatively, the product of an online advertisement's pCTR and the advertiser's corresponding cost-per-click (CPC) bid. Management apparatus 204 may further select online advertisement 220 based on a combination of eCPI, bids 218, and/or and a set of quality scores related to the relevance of the online advertisements to the user and/or context 226.

By applying context-based constraints (e.g., constraints 208 and 224) to online advertising auctions for online advertisement slot 222, the system of FIG. 2 may enable finer-grained control of various attributes and/or metrics associated with the online advertising auctions. For example, the setting of constraints on pCTR and/or other user-related metrics may maintain the quality of content shown through interface 102 and/or improve user engagement with online advertisements in online advertisement slot 222. At the same time, the constraints may be used to estimate values of other metrics, thus providing a clearer picture of the effect the constraints may have on the online advertising auctions and/or serving of online advertisements in online advertisement slot 222. Finally, the constraints may be applied to an optimization technique that maximizes or minimizes one metric by adjusting constraints on one or more other metrics across a variety of contexts associated with advertising in online advertisement slot 222.

Those skilled in the art will appreciate that the system of FIG. 2 may be implemented in a variety of ways. First, analysis apparatus 202, management apparatus 204, and prediction apparatus 206 may be implemented as a single physical machine, multiple computer systems, one or more virtual machines, a grid, one or more databases, one or more filesystems, and/or a cloud computing system.

Moreover, analysis apparatus 202, management apparatus 204, and prediction apparatus 206 may be implemented together and/or separately by one or more hardware and/or software components and/or layers. For example, analysis apparatus 202, management apparatus 204, and prediction apparatus 206 may be provided by ad server 118, front-end server 112, and/or other components of system 120 of FIG. 1. In another example, analysis apparatus 202 may be provided by an offline data-processing component that generates a set of tradeoff curves for a number of contexts and uses the tradeoff curves to obtain a set of values (e.g., value 212) for a metric in the tradeoff curves that meet various context-specific constraints (e.g., constraint 208) on another metric in the tradeoff curves. Values obtained by analysis apparatus 202 may then be used by an online component implementing management apparatus 204 to ensure that online advertising auctions for online advertising slot 222 meet the constraints and/or estimates of the values.

Finally, data used by analysis apparatus 202, management apparatus 204, prediction apparatus 206, and/or other components of the system may be obtained and/or stored in various ways. For example, analysis apparatus 202 may store context 226, constraint 208, tradeoff curve 210, and/or value in data repository 230 and/or another repository associated with managing online advertising. Bids 218 and predicted values 216 used and/or generated by management apparatus 204 and prediction apparatus 206, respectively, may also be stored in the repository for subsequent retrieval and/or use.

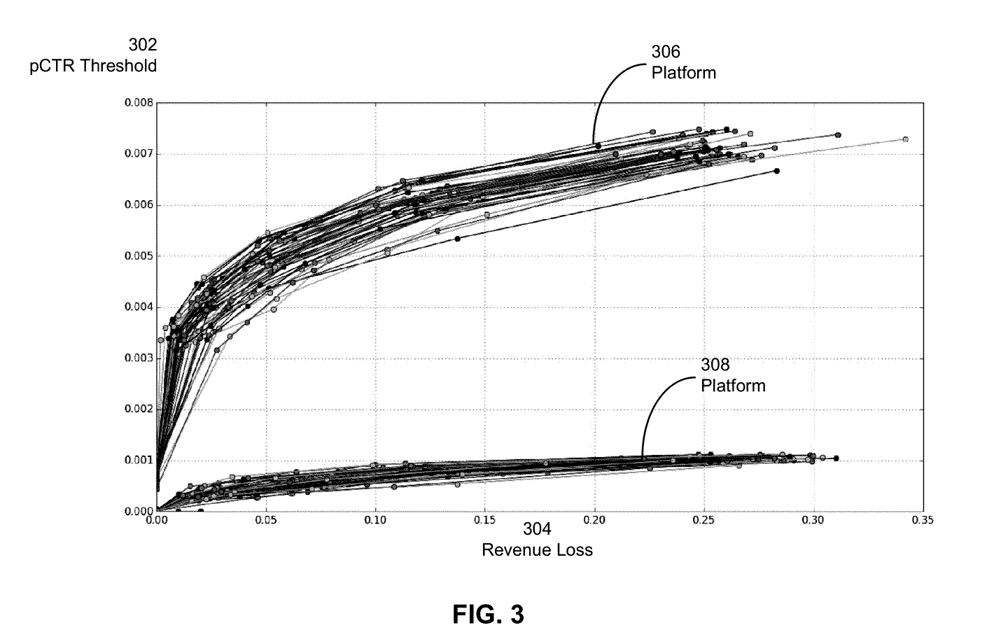

FIG. 3 shows a set of exemplary tradeoff curves in accordance with the disclosed embodiments. More specifically, FIG. 3 shows a plot of tradeoff curves of pCTR threshold 302 and revenue loss 304 in a number of different online advertising contexts (e.g., context 226 of FIG. 2).

In these tradeoff curves, pCTR threshold 302 represents a minimum pCTR that an online advertisement must meet to be included in an online advertising auction (e.g., in a particular context). For example, a pCTR threshold 302 of 0.1% (i.e., 0.001) would prevent online advertisements with pCTRs below 0.1% from participating in the online advertising auction. Revenue loss indicates lost revenue caused by excluding online advertisements that do not meet pCTR threshold 302 from the online advertising auction.

For example, three online advertisements with pCTRs of 1%, 0.9%, and 2% and bids of $10, $5, and $2, respectively, may participate in an online advertising auction for an online advertisement slot (e.g., online advertisement slot 222 of FIG. 2). If no pCTR threshold is set for the online advertising auction, the expected revenue from the online advertising auction may be the pCTRs of the three online advertisements multiplied by their bids, or 10*0.01+5*0.009+2*0.02, which comes out to 0.185. Conversely, if a pCTR threshold were set to 1%, the second online advertisement with a pCTR of 0.9% may be excluded from the online advertising auction, and resulting revenue loss may be represented as a proportion of total revenue, or 0.045/0.185, which comes out to 0.243. However, if the excluded online advertisement were replaced by a fourth online advertisement with a pCTR of 1.5% and a $2 bid, revenue from the fourth online advertisement may make up for a portion of the revenue loss. In turn, the revenue loss may be calculated from the difference in revenue between the two online advertisements as a proportion of total revenue, or (0.045−0.03)/0.185, which comes out to 0.081.

Points on each tradeoff curve in FIG. 3 may thus be calculated by “sweeping” the value of pCTR threshold 302 within a range (e.g., from 0% to 0.8%) while rerunning an online advertising auction in each context and calculating the revenue associated with each rerun. Revenue loss 304 may then be calculated as the proportional difference in revenue between the rerun online advertising auction and the revenue for an online advertising auction with a 0% pCTR threshold 302.

As shown in FIG. 3, revenue loss 304 may increase with pCTR threshold 302 because an increase in pCTR threshold 302 may result in the exclusion of more revenue-producing online advertisements from the online advertising auction. In addition, points in the tradeoff curves 3 may form two distinct “clusters” represented by two different platforms 306-308 associated with the context of the online advertising auction. For example, platform 308 may be a desktop platform, while platform 306 may be a mobile platform.

The clustered tradeoff curves may indicate that revenue loss 304 for platform 308 (e.g., desktop) increases more sharply with pCTR threshold 302 than revenue loss 304 for platform 306 (e.g., mobile). Consequently, the generation of tradeoff curves for different contexts (e.g., platforms 306-308, user segments, times, etc.) may enable the identification of distinct patterns related to the contexts and further facilitate the context-based management of online advertising auctions. For example, the tradeoff curves may allow different context-based values of pCTR threshold 302 to be set for a 0.05 revenue loss 304, with values of pCTR threshold 302 for platform 306 ranging from slightly less than 0.4% to about 0.55% and values of pCTR threshold 302 for platform 308 ranging from about 0.02% to 0.08%. Consequently, pCTR threshold 302 may be tailored to different usage patterns, environments, users, and/or other contexts, thus enabling the fine-tuning of online advertising auctions related to the contexts and facilitating more accurate estimates of revenue loss 304 and/or other metrics for the online advertising auctions.

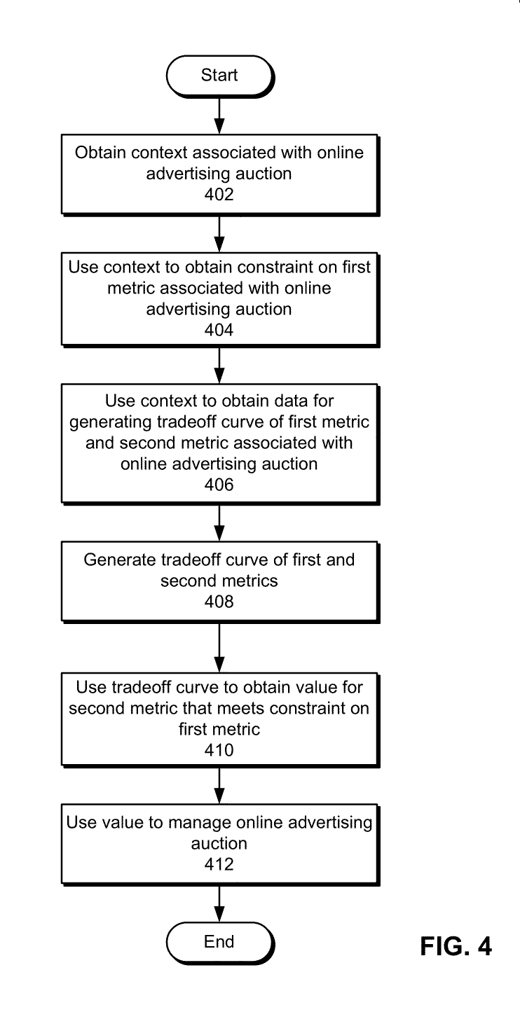

FIG. 4 shows a flowchart illustrating the process of managing online advertising in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

Initially, a context associated with an online advertising auction is obtained (operation 402). For example, the context may include a user, a time, a platform, and/or other attributes that may be used to customize the management of the online advertising auction. Next, the context is used to obtain a constraint on a first metric associated with the online advertising auction (operation 404). For example, the user, platform, and/or time of the context may be matched to a constraint that specifies a minimum or maximum threshold for the first metric.

The context is also used to obtain data for generating a tradeoff curve of the first metric and a second metric associated with the online advertising auction (operation 406). For example, the data may include historical data from other online advertising auctions associated with the context. The historical data may include values for the first and second metrics from the other online advertising auctions.

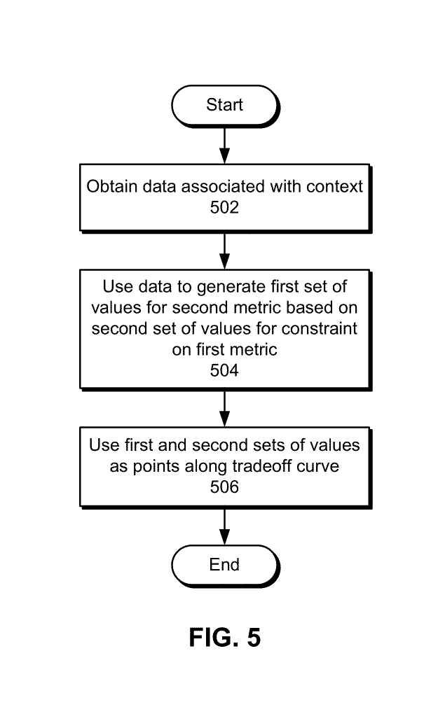

Once the data is obtained, the tradeoff curve is generated (operation 408), as described in further detail below with respect to FIG. 5. For example, the first and second metrics may be associated with revenue and one or more user actions, such as clicks (e.g., ad clicks), likes, dislikes, hides (e.g., hiding of sponsored content in a stream or feed of organic content), shares, comments, and/or follows (e.g., following a user or organization associated with an online advertisement). One or more tradeoff curves may be generated to determine the effect of the user action constraints on revenue or revenue loss. Alternatively, the tradeoff curve(s) may be used to identify patterns in revenue or revenue loss associated with one or more constraints on user actions in one or more contexts.

The trade off curve is then used to obtain a value for the second metric that meets the constraint on the first metric (operation 410). In particular, the value may be obtained from a point on the tradeoff curve that matches the constraint. Continuing with the above example, a constraint on a user action such as a minimum pCTR may be used as one coordinate of a point on the tradeoff curve, and a value for revenue or revenue loss may be obtained from the other coordinate of the same point. Conversely, a constraint on revenue (e.g., minimum revenue, maximum revenue loss) may be used as the known coordinate of the point, and the other coordinate of the point may be used as the value of a pCTR threshold that meets the constraint.

Finally, the value is used to manage the online advertising auction (operation 412). In particular, the value may be used as an estimated value for the second metric (e.g., estimated revenue or revenue loss for a given pCTR threshold) and/or an additional constraint on the online advertising auction (e.g., pCTR threshold for a given revenue or revenue loss).

To apply the additional constraint, a set of predicted values of the second metric may be generated for a set of online advertisements participating in the online advertising auction, and a subset of the online advertisements with a subset of the predicted values that do not meet the additional constraint may be removed. Each predicted value of the second metric may be obtained as a quantile from a distribution of values of the second metric for an online advertisement. As a result, the quantile may be adjusted up to produce a higher (e.g., more optimistic) predicted value (e.g., pCTR) or down to produce a lower (e.g., less optimistic) predicted value (e.g., pCTR) for the second metric. For example, a pCTR for a newer online advertisement may be obtained as the 95^{th} percentile of the pCTR distribution for the newer online advertisement to facilitate inclusion of the newer online advertisement in the online advertising auction.

FIG. 5 shows a flowchart illustrating the process of generating a tradeoff curve in accordance with the disclosed embodiments. In one or more embodiments, one or more of the steps may be omitted, repeated, and/or performed in a different order. Accordingly, the specific arrangement of steps shown in FIG. 5 should not be construed as limiting the scope of the embodiments.

Initially, data associated with a context is obtained (operation 502). The data may include historical data associated with the context. For example, the historical data may include data from previous online advertising auctions associated with the context, such as pCTRs and/or bids for online advertisements participating in the online advertising auctions from the previous week.

Next, the data is used to generate a first set of values for a second metric based on a second set of values for a constraint on a first metric (operation 504). For example, the value of the constraint on the first metric may be “swept” within a range, and an online advertising replay may be conducted for each value of the constraint to determine a corresponding value for the second metric that allows the constraint to be satisfied. The first and second sets of values are then used as points along the tradeoff curve (operation 506). For example, the tradeoff curve may be fit to pairs of values for the first and second metrics.

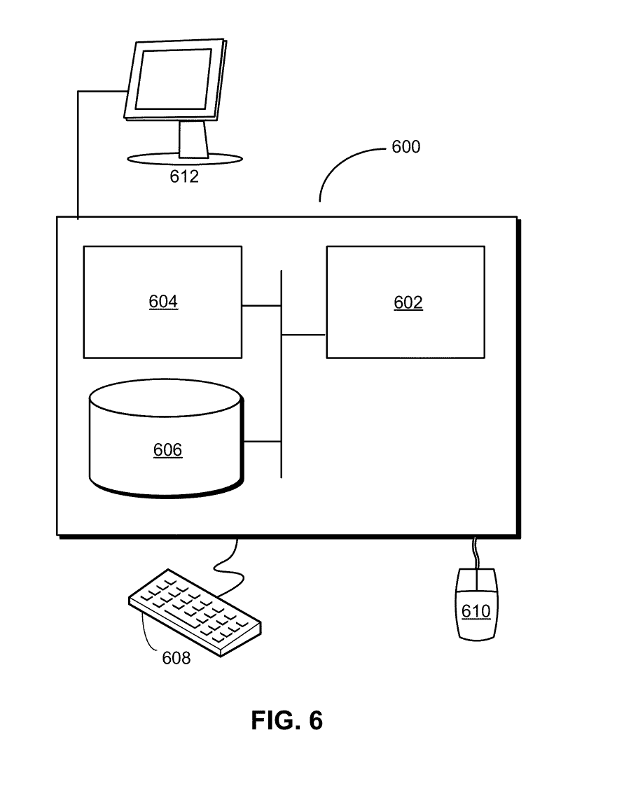

FIG. 6 shows a computer system 600 in accordance with an embodiment. Computer system 600 includes a processor 602, memory 604, storage 606, and/or other components found in electronic computing devices. Processor 602 may support parallel processing and/or multi-threaded operation with other processors in computer system 600. Computer system 600 may also include input/output (I/O) devices such as a keyboard 608, a mouse 610, and a display 612.

Computer system 600 may include functionality to execute various components of the present embodiments. In particular, computer system 600 may include an operating system (not shown) that coordinates the use of hardware and software resources on computer system 600, as well as one or more applications that perform specialized tasks for the user. To perform tasks for the user, applications may obtain the use of hardware resources on computer system 600 from the operating system, as well as interact with the user through a hardware and/or software framework provided by the operating system.

In one or more embodiments, computer system 600 provides a system for managing online advertising. The system may include an analysis apparatus that obtains a constraint on a first metric associated with an online advertising auction and generates a tradeoff curve of the first metric and a second metric associated with the online advertising auction. The analysis apparatus may also use the tradeoff curve to obtain a value for the second metric that meets the constraint on the first metric. The system may also include a management apparatus that uses the value to manage the online advertising auction. For example, the management apparatus may use the value as an estimated value for the second metric and/or an additional constraint on the online advertising auction. Finally, the system may include a prediction apparatus that generates a set of predicted values of the second metric for the advertisements so that management apparatus may remove a subset of the advertisements with a subset of the predicted values that do not meet the additional constraint. For example, the prediction apparatus may obtain a predicted value of the second metric for an online advertisement as a quantile from a distribution of values of the second metric for the online advertisement.

In addition, one or more components of computer system 600 may be remotely located and connected to the other components over a network. Portions of the present embodiments (e.g., analysis apparatus, management apparatus, prediction apparatus, etc.) may also be located on different nodes of a distributed system that implements the embodiments. For example, the present embodiments may be implemented using a cloud computing system that generates a set of tradeoff curves, estimated values, and/or constraints for managing online advertising to a set of remote users and/or electronic devices.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A computer-implemented method for managing online advertising, comprising:
obtaining a constraint on a first metric associated with an online advertising auction;
using a computer to:
generate a tradeoff curve of the first metric and a second metric associated with the online advertising auction; and
use the tradeoff curve to obtain a value for the second metric that meets the constraint on the first metric; and
using the value to manage the online advertising auction.

2. The computer-implemented method of claim 1, further comprising:
obtaining a context associated with the online advertising auction; and
using the context to obtain the constraint and data for generating the tradeoff curve.

3. The computer-implemented method of claim 2, wherein the context comprises a user, a platform, and a time.

4. The computer-implemented method of claim 2, wherein the data comprises historical data from other online advertising auctions associated with the context.

5. The computer-implemented method of claim 2, wherein generating the tradeoff curve comprises:
using the data to generate a first set of values for the second metric based on a second set of values for the constraint on the first metric; and
using the first and second sets of values as points along the tradeoff curve.

6. The computer-implemented method of claim 1, wherein using the tradeoff curve to obtain the value for the second metric that meets the constraint on the first metric comprises:
obtaining the value for the second metric from a point on the tradeoff curve that matches the constraint.

7. The computer-implemented method of claim 1, wherein using the value to manage the online advertising auction comprises at least one of:
using the value as an estimated value for the second metric; and
using the value as an additional constraint on the online advertising auction.

8. The computer-implemented method of claim 7, wherein using the value as the additional constraint on the online advertising auction comprises:
generating a set of predicted values of the second metric for a set of online advertisements participating in the online advertising auction; and
removing a subset of the online advertisements with a subset of the predicted values that do not meet the additional constraint.

9. The computer-implemented method of claim 8, wherein generating the set of predicted values of the second metric for the online advertisements comprises:
obtaining a predicted value of the second metric for an online advertisement as a quantile from a distribution of values of the second metric for the online advertisement.

10. The computer-implemented method of claim 1, wherein the first and second metrics are related to revenue and one or more user actions.

11. The computer-implemented method of claim 10, wherein the one or more user actions comprise at least one of a click, a like, a dislike, a hide, a share, a comment, and a follow.

12. The computer-implemented method of claim 10, wherein using the value to manage the online advertising auction comprises at least one of:
using the constraint on the one or more user actions to estimate the value associated with the revenue; and
using the constraint on the revenue to determine an additional constraint on the one or more user actions in the online advertising auction.

13. A system comprising a non-transitory computer-readable storage medium storing instructions that when executed by a computer cause the computer to perform a method for managing online advertising, comprising:
an analysis apparatus configured to:
obtain a constraint on a first metric associated with an online advertising auction;
generate a tradeoff curve of the first metric and a second metric associated with the online advertising auction; and
use the tradeoff curve to obtain a value for the second metric that meets the constraint on the first metric; and
a management apparatus configured to use the value to manage the online advertising auction.

14. The system of claim 13, wherein the analysis apparatus is further configured to:
obtain a context associated with the online advertising auction; and
use the context to obtain the constraint and data for generating the tradeoff curve.

15. The system of claim 14, wherein generating the tradeoff curve comprises:
using the data to generate a first set of values for the second metric based on a second set of values for the constraint on the first metric; and
using the first and second sets of values as points along the tradeoff curve.

16. The system of claim 13, wherein using the value to manage the online advertising auction comprises at least one of:
using the value as an estimated value for the second metric; and
using the value as an additional constraint on the online advertising auction.

17. The system of claim 16, wherein using the value as the additional constraint on the online advertising auction comprises:
obtaining a set of predicted values of the second metric for a set of online advertisements participating in the online advertising auction; and
removing a subset of the online advertisements with a subset of the predicted values that do not meet the additional constraint.

18. The system of claim 13, wherein the first and second metrics are related to revenue and one or more user actions.

19. The system of claim 18, wherein using the value to manage the online advertising auction comprises at least one of:
using the constraint on the one or more user actions to estimate the value associated with the revenue; and
using the constraint on the revenue to determine an additional constraint on the one or more user actions in the online advertising auction.

20. An apparatus, comprising:
one or more processors; and
memory storing instructions that, when executed by the one or more processors, cause the apparatus to:
obtain a constraint on a first metric associated with an online advertising auction;
generate a tradeoff curve of the first metric and a second metric associated with the online advertising auction;
use the tradeoff curve to obtain a value for the second metric that meets the constraint on the first metric; and
use the value to manage the online advertising auction.
